(19) United States
(12) Patent Application Publication
(10) Pub. No.: US 2026/0084668 A1
(43) Pub. Date: Mar. 26, 2026

(54) MANAGEMENT OF PARKING BRAKE ASSEMBLY UNDER HIGH FRICTION CONDITIONS

(71) Applicant: HL MANDO CORPORATION, Gyeonggi-do (KR)

(72) Inventors: Gyunghun SIM, Auburn, MI (US); Manoj Kumar Reddy MOTAKATLA, Auburn, MI (US)

(21) Appl. No.: 19/273,821

(22) Filed: Jul. 18, 2025

Related U.S. Application Data
(60) Provisional application No. 63/697,423, filed on Sep. 20, 2024.

(51) Int. Cl. B60T 8/172; B60T 8/171; B60T 13/74; F16D 55/226; F16D 65/18; F16D 121/24; F16D 125/44; F16D 127/06

(52) U.S. Cl. CPC B60T 8/172; B60T 8/171; B60T 13/746; F16D 55/226; F16D 65/18; F16D 2121/24; F16D 2125/44; F16D 2127/06

(57) ABSTRACT

An electromechanical brake system includes: an actuator assembly having an electric motor configured to generate torque for moving a brake pad assembly to apply or release a brake and a driven pulley configured to transmit the torque generated from the electric motor; a parking brake assembly having a parking pawl configured to engage against the driven pulley in a parking brake applied state of a vehicle and a pawl actuator configured to move the parking pawl to engage against the driven pulley; and an electronic control unit (ECU) that is configured to control the electric motor by determining whether the electric motor should be controlled to apply the torque in a direction of releasing the brake to ensure a stable engagement between the parking pawl and the driven pulley during the parking brake applied state of the vehicle using a change in motor rotation of the electric motor.

### CROSS REFERENCE TO PARENT APPLICATIONS

This application claims the benefit of U.S. Patent Application Ser. No. 63/697,423 filed on Sep. 20, 2024, entitled “EMB'S PARKING BRAKE APPLY METHOD AT HIGH FRICTION STATUS”, the entirety of which is incorporated herein by reference.

### BACKGROUND

Various embodiments of the present disclosure generally relate to an electromechanical brake (EMB) system (also referred to herein as an “EMB assembly”) and more particularly to an inductive position sensor of the EMB system.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock or “ABS,” EMB systems, and electric or “brake by wire.”

For example, in a hydraulic brake system, the hydraulic fluid transfers energy from a brake pedal to a brake pad for slowing down or stopping rotation of a wheel of the vehicle. In an electric brake system, the application and release of the brake is controlled by an electric caliper via electrical signal. The electric brake system typically includes an electric actuator connected to a brake caliper either by a cable, as the drum in head, or directly attached to the brake caliper. The electric actuator converts electrical power to rotational mechanical output power for moving the cable or drive screw and applying the brakes.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, an electromechanical brake (EMB) assembly may comprise: an actuator assembly comprising an electric motor configured to generate torque for moving a brake pad assembly to apply or release a brake and a driven pulley configured to transmit the torque generated from the electric motor; a parking brake assembly comprising a parking pawl configured to engage against the driven pulley in a parking brake applied state of a vehicle and a pawl actuator configured to move the parking pawl to engage against the driven pulley; and an electronic control unit (ECU) coupled to the actuator assembly and the parking brake assembly, the ECU configured to control the electric motor by determining whether the electric motor should be controlled to apply the torque in a direction of releasing the brake to ensure a stable engagement between the parking pawl and the driven pulley during the parking brake applied state of the vehicle based on change in motor rotation of the electric motor.

The ECU is configured to, as part of determining whether the electric motor should be controlled to apply the torque in a direction of releasing the brake: obtain a request to apply the parking brake assembly to transition the vehicle into the parking brake applied state; cause, in response to the request to apply the parking brake, the parking pawl to engage with the driven pulley; determine, after the parking pawl is caused to engage with the driven pulley, whether the change in the motor rotation of the electric motor has exceeded a preset motor rotation change value; and control the electric motor to apply the torque in the direction of releasing the brake based on the determination of whether the change in the motor rotation of the electric motor has exceeded the preset motor rotation change value.

The ECU is configured to, in response to a determination that the change in the motor rotation of the electric motor has exceeded a preset motor rotation change value, control the electric motor not to apply the torque in the direction of releasing the brake.

The ECU is configured to, in response to a determination that the change in the motor rotation of the electric motor has not exceeded a preset motor rotation change value, control the electric motor to apply the torque in the direction of releasing the brake.

The ECU is further configured to determine a starting point and an ending point of a parking pawl engaging time of the parking pawl based on the torque of the electric motor, wherein the change in the motor rotation of the electric motor is a change in the motor rotation measured between the starting point and the ending point of the parking pawl engaging time.

The ECU is further configured to determine, after the parking pawl is caused to engage with the driven pulley and using a motor torque of the electric motor, whether the torque of the electric motor has ramped down from a peak motor torque value to a preset motor torque value, wherein the change in the motor rotation of the electric motor is a change in the motor rotation measured between the peak motor torque value and the preset motor torque value.

The ECU is configured to control the electric motor to apply the torque in the direction of releasing the brake to move the driven pulley to a parking pawl set range preset for a stable parking brake applied condition based on the change in the motor rotation of the electric motor.

According to various embodiments of the present disclosure, an electromechanical brake (EMB) assembly may comprise: a brake rotor configured to be rotatable with a wheel of a vehicle; a brake pad assembly configured to be engageable with the brake rotor; an actuator assembly comprising an electric motor configured to generate torque for moving the brake pad assembly and a driven pulley configured to transmit the torque generated from the electric motor; a parking brake assembly comprising a parking pawl configured to engage against the driven pulley in a parking brake applied state of the vehicle and a pawl actuator configured to move the parking pawl to engage against the driven pulley; and an electronic control unit (ECU) coupled to the actuator assembly and the parking brake assembly, the ECU configured to control the electric motor by determining whether the electric motor should be controlled to apply the torque in a direction of releasing the brake to ensure a stable engagement between the parking pawl and the driven pulley during the parking brake applied state of the vehicle based on change in motor rotation of the electric motor.

According to some embodiments of the present disclosure, a method for controlling an electromechanical brake (EMB) assembly may comprise: determining whether an electric motor of the EMB assembly should be controlled to apply a torque in a direction of releasing a brake to ensure a stable engagement between a driven pully, configured to transmit the torque generated from the electric motor, and a parking pawl, configured to engage against the driven pulley in a parking brake applied state of a vehicle, during the parking brake applied state based on change in motor rotation of the electric motor; and controlling the electric motor of the EMB assembly in response to determination of whether the electric motor of the EMB assembly should be controlled to apply the torque in the direction of releasing the brake during the parking brake applied state based on the change in the motor rotation of the electric motor.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a cross-sectional view of a brake assembly according to one or more exemplary embodiments of the present disclosure.

FIG. 2A shows a cross-sectional view of a parking brake of the brake assembly of FIG. 1 according to one or more exemplary embodiments of the present disclosure.

FIGS. 2B and 2C show graphs illustrating parking brake application situations according to one or more exemplary embodiments of the present disclosure.

FIG. 3 shows a flowchart according to one or more exemplary embodiments of the present disclosure.

FIG. 4 shows a schematic view of a vehicle including a steering system and a brake assembly according to one or more exemplary embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

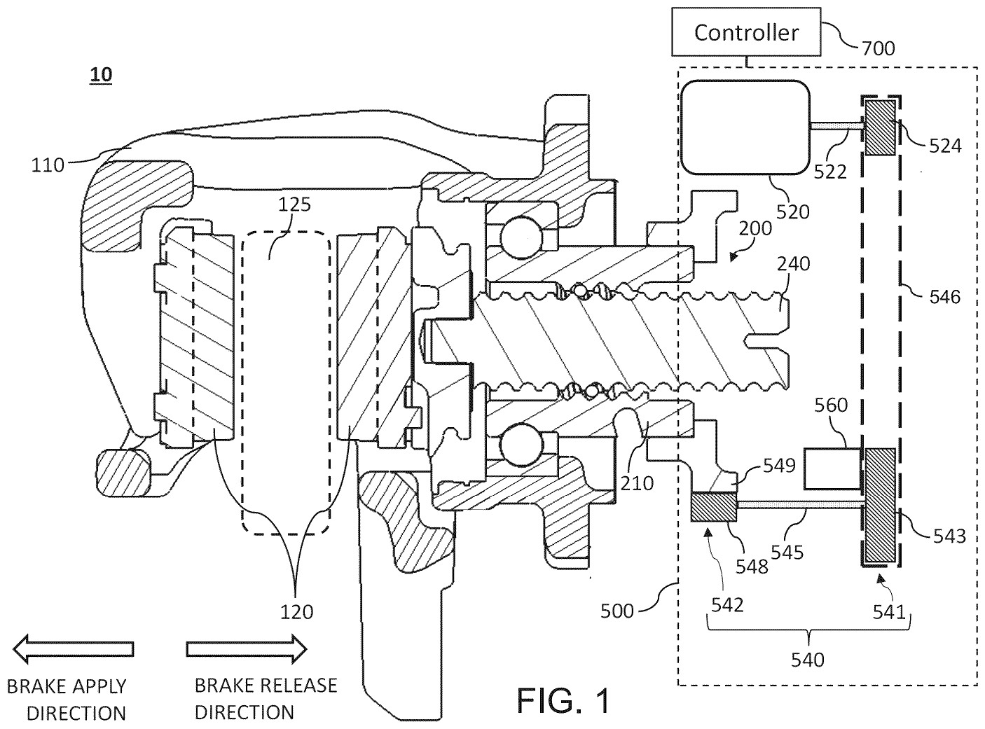

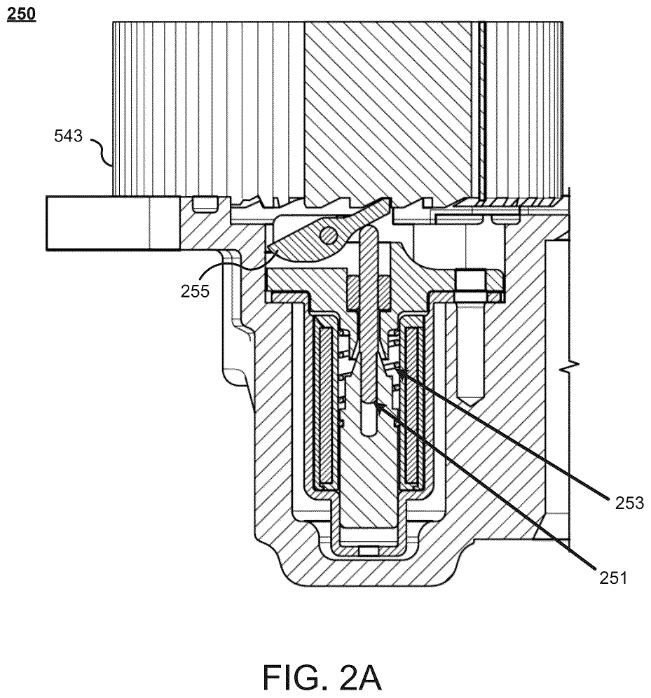

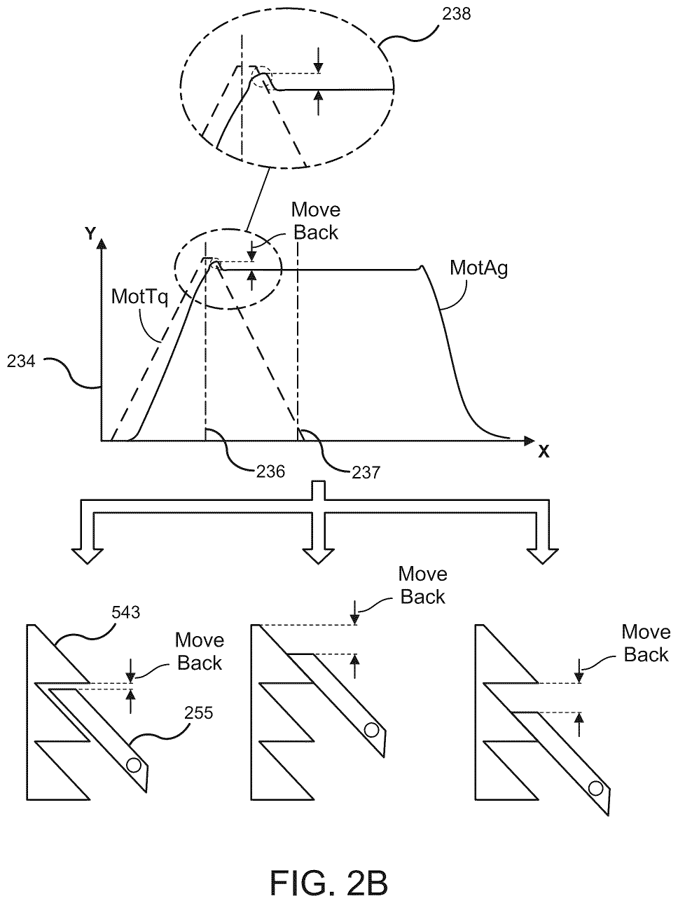

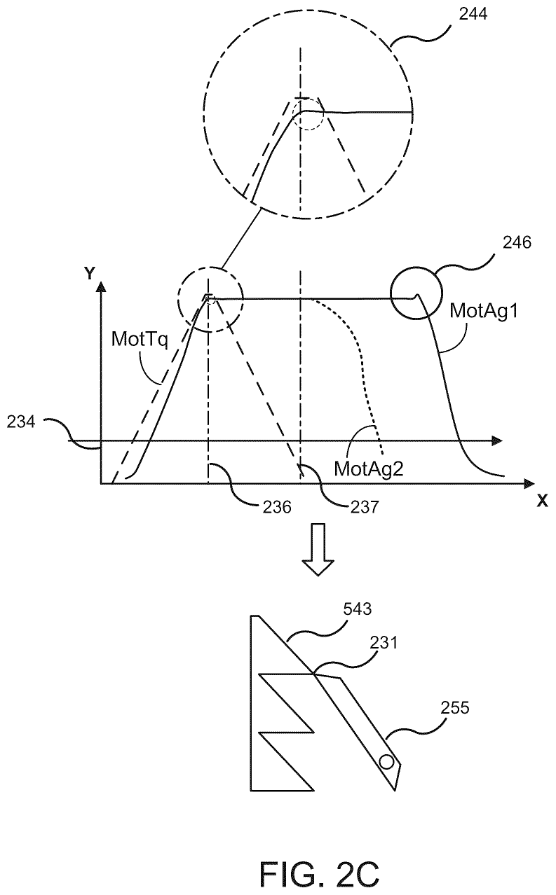

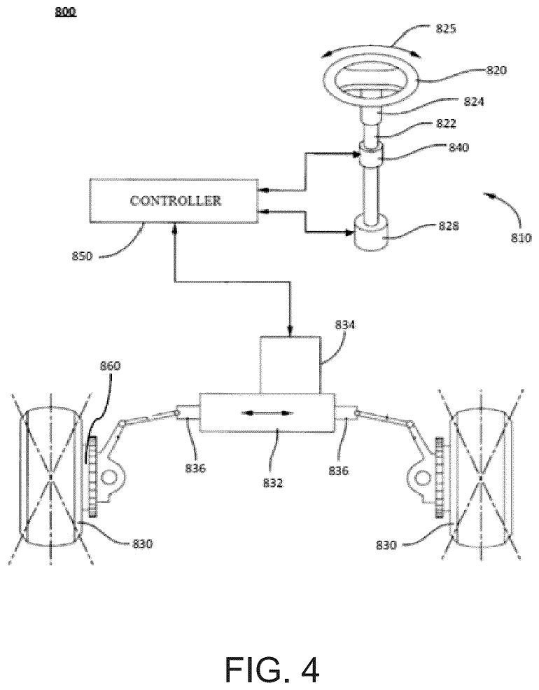

A vehicle (see, e.g., FIG. 4) may be equipped with one or more brake systems (e.g., an EMB system or the like) for slowing down or stopping rotation of a wheel of the vehicle (e.g., providing braking and stopping capabilities for vehicle). Such brake systems may be equipped with a parking brake to prevent movement of wheels when the vehicle is not in operation, for instance, when the vehicle is stopped or parked. The parking brake may refer to a mechanism for restraining or holding a parked vehicle in place. The parked status of the vehicle can be maintained by a parking lock mechanism, for example, but not limited to, a strut, a parking pawl (e.g., 255 of FIG. 2A), engagement of one or more gears, and so on. More specifically, according to some embodiments of the present disclosure, when a parking brake (e.g., of an electromechanical brake (EMB) assembly is applied, a latch-like structure (e.g., a latch, a parking pawl, or the like) engages with a gear (e.g., driven pulley 543 of FIGS. 1 and 2A, or the like) to prevent the gear from moving while the parking brake is applied. A reliable parking brake that can be operated safely and reliably in any type of environments (e.g., in below freezing temperatures, in high friction situations, or the like) is particularly important and sought after.

Referring to FIG. 1, a brake assembly 10 may include a brake caliper 110 mounted in a floating manner by means of a brake carrier. When the vehicle is in motion, a brake rotor 125 may rotate with a wheel about an axle of the vehicle. A brake pad assembly (or brake lining assembly) 120 (e.g., an electromechanical brake (EMB) system, or the like) is provided in the brake caliper 110. The brake caliper 110 may include a bridge with fingers, and the fingers of the brake caliper 110 may be in contact with the brake pad assembly 120. Each brake pad of the brake pad assembly 120 is disposed with a small air clearance on a side of the brake rotor 125, such as a brake disc, in a release position so that no significant residual drag moment occurs.

The brake assembly 10 may comprise a screw mechanism 200 (e.g., a ball screw mechanism or a nut-screw mechanism) configured to convert rotary motion generated by an actuator assembly 500 into linear motion in order to move the brake pad assembly 120 (namely, the right brake pad of the brake pad assembly 120) toward or away from the brake rotor 125 in an axial direction. The screw mechanism 200 may include a rotatable part 210 and a translatable part 240. For example, the rotatable part 210 may comprise a nut or a ball nut and the translatable part 240 may comprise a screw or a ball screw, although not required. The rotatable part 210 is operably coupled to the actuator assembly 500 and is configured to be rotatable by actuation of the actuator assembly 500.

The actuator assembly 500 may comprises the electric motor 520. For example, the electric motor 520 may be directly engaged with the rotatable part 210. Alternatively, the electric motor 520 is indirectly connected to the rotatable part 210 through means for transferring rotary force generated by the electric motor 520, such as one or more gears, one or more belts, one or more pulleys, and/or any other connecting means and combination thereof.

The actuator assembly 500 may have a multi-stage drive mechanism 540, although not required. The multi-stage drive mechanism 540 may be, for example, but is not limited to, a dual-stage drive mechanism comprising a belt drive mechanism 541 and a gear drive mechanism 542 to multiply torque from the electric motor 520 to supply rotary force to the rotatable part 210 of the drive mechanism 540. The belt drive mechanism 541 multiplies the torque from the electric motor 520 by using a drive pully 524 and a driven pulley 543 rotatably connected by a drive belt 546, and the torque multiplied by the belt drive mechanism 541 is delivered to the gear drive mechanism 542 through the intermediate shaft 545. The intermediate shaft 545 may connect the driven pulley 543 of the belt drive mechanism 541 to a first gear 548 of the gear drive mechanism 542 in order to deliver rotary torque, generated by the electric motor 520 and transmitted through the belt drive mechanism 541, to the gear drive mechanism 542. The first gear 548 is rotatably engaged with the second gear 549 to rotate the second gear 549 by the rotary torque transmitted through the intermediate shaft 545. The second gear 549 may be formed directly on a part of the circumferential surface of a rotatable body or nut of rotatable part 210 of the drive mechanism 540 or screw mechanism 200 or be mounted to the rotatable body of rotatable part 210 of the drive mechanism 540 to rotate the rotatable body or nut of rotatable part 210.

The mechanical connection between the electric motor 520 and the brake pad assembly 120 described above and illustrated in FIG. 1 is an example for illustration purposes only, and the present disclosure is not limited thereto. Any structure, configuration, and arrangement of the mechanical connection that can mechanically connect the electric motor 520 to the brake pad assembly 120 can be used.

Because the electric motor 520 and the brake pad assembly 120 are mechanically connected to each other, the movement of the brake pad assembly 120 (namely, movement in the right brake pad of the brake pad assembly 120) can cause the electric motor 520 to move. For instance, if the brake pad assembly 120 moves, a rotor of the electric motor 520 (e.g., the motor shaft 522) can rotate. Accordingly, if the brake pad assembly 120 moves in the brake release direction after the parking brake is applied, the displacement of the brake pad assembly 120 in the brake release direction can cause the rotor of the electric motor 520 (e.g., the motor shaft 522) to rotate due to the mechanical connection between the electric motor 520 and the brake pad assembly 120. As a result, a position of the electric motor 520 can be used to determine a linear position of the brake pad assembly 120, and vice versa.

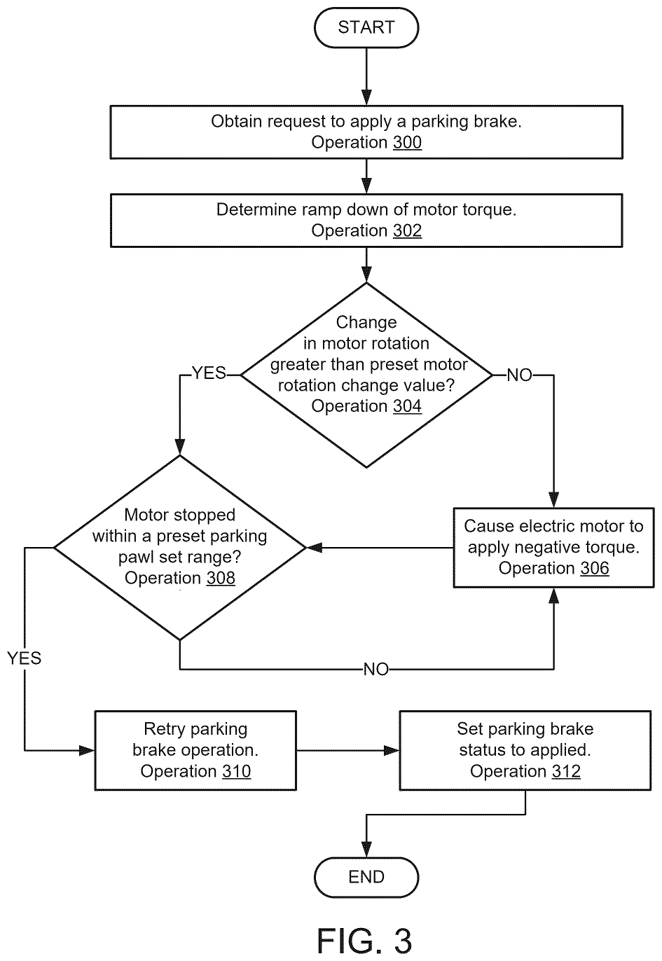

To detect such changes in the linear position of the brake pad assembly 120, brake assembly 10 may further include a controller 700 that is able to measure a movement and/or position of the electric motor 520 (e.g., via one or more sensors not shown in FIG. 1) and a torque (e.g., motor torque) generated by the electric motor 520. The controller 700 may also be configured to control the electric motor 520 to perform braking operations of the brake assembly 10 (e.g., the above discussed movement of the translatable part 240 to cause the brake pad assembly 120 to engage with the brake rotor 125). One example of the sensors configured to be installed within the brake assembly 10 may be the inductive position sensor of embodiments disclosed herein that is described in more detail in reference to FIGS. 2A-3B.

These one or more sensors may include any type and combination of sensors including, but not limited to: (i) force sensors, (ii) motor angle sensors; (iii) linear position sensors; (iv) temperature sensors; (v) current sensors; (iv) torque sensors; or the like. These one or more sensors may also be disposed (e.g., installed) within any portion of the brake assembly that is in proximity of the component or components that the sensors are configured to monitor and from which the sensors are configured to obtain measurements (e.g., obtain sensor readings from).

The controller 700 may also be configured to receive instructions (e.g., digital instructions) from a main computing system (e.g., via a serial connection bus such as a controller area network (CAN), bus or the like) of the vehicle to modify one or more parameters and/or capabilities of the brake assembly 10. The main computing system of the vehicle may be, for example, a chassis controller or the like.

The controller 700 may be, for example, but not limited to, a micro-controller unit (MCU), an electronic control unit (ECU), a circuit chip, a semiconductor circuit, and a circuit board having memory (e.g., for storing instructions to be executed by one or more processors coupled to the memory), one or more processors, and electric components. The controller 700 may be coupled to (e.g., one or more components of) the actuator assembly.

FIG. 2A shows a parking brake 250 (also referred to herein as a “parking brake assembly”) of the brake assembly 10 of FIG. 1 in accordance with one or more exemplary embodiments of the present disclosure.

As shown in FIG. 2A, the parking brake assembly 250 may include an actuating mechanism (also referred to herein as a “pawl actuator”) made up of, for example, an armature and pin assembly 251 and a solenoid spring 253. The actuating mechanism may be configured to actuate parking pawl 255 such that parking pawl 255 engages with driven pulley 543 (namely, with one or more teeth of the driven pulley 543) to prevent movement of the driven pulley 543 when a parking brake operation is performed.

Although the actuating mechanism is shown in FIG. 2A as being made up of an armature and pin assembly 251 and a solenoid spring 253, other mechanical systems and/or assemblies that are capable of physically actuating the parking pawl 255 may also be used (instead of the armature and pin assembly 251 and solenoid spring 253 combination of FIG. 2A) without departing from the scope of embodiments disclosed herein.

In embodiments, operation of the actuating mechanism may also be controlled by controller 700 of the brake assembly 10. For example, during a parking brake application operation, the controller 700 may cause (e.g., via providing one or more analog and/or digital signals to armature and pin assembly 251) the armature and pin assembly 251 to push the parking pawl 255 against the driven pulley 243 such that the parking pawl 255 is locked into one of the teeth of the driven pulley 543 (which generates a high clamp force that prevents movement of the driven pulley 543).

The controller 700 may also monitor properties of one or more components of the brake assembly 10 (e.g., a motor rotation and/or motor angle of electric motor 50, a clamp force between the parking pawl and the driven pulley 543, or the like) to ensure that the parking brake is properly applied (e.g., that the parking pawl 255 is properly engaged with driven pulley. For example, high friction force between the parking pawl 255 and the driven pulley 543 can lead to failure in the application of the parking brake (e.g., failure in the proper engagement of the parking pawl 255 with the driven pulley 543). In particular, high friction force between the parking pawl 255 and the driven pulley 543 may be present in situations such as, but not limited to: (i) when the vehicle is operating in below freezing ambient temperatures; (ii) when physical properties lubricant between the parking pawl 255 and driven pulley 543 change; (iii) aging of the components; or the like. Additional details regarding the monitoring are discussed in reference to FIG. 3.

FIGS. 2B and 2C are now presented to show how the controller 700 may be able to determine whether the parking brake has been properly applied (e.g., whether the parking pawl 255 and the driven pulley 543 are properly engaged with one another to create a stable parking brake application situation).

Starting with the stable parking brake application scenarios of FIG. 2B, a graph 234 is presented showing a change in motor torque MotTq and motor rotation MotAg (e.g., the y-axis of graph 234) over time (e.g., the x-axis of the graph 234) as the parking brake is applied. As shown in graph 234, as the parking brake is applied, the motor torque MotTq ramps up, holds still for a period of time, and then ramps down.

In embodiments, the parking pawl 255 of FIG. 2A (or other latch-like structure) is applied to engage with the driven pulley 543 of FIG. 2A at point 236 of graph 234 (e.g., at the peak of motor torque MotTq). When the motor torque MotTq ramps down after such engagement between the driven pulley 543 and the parking pawl 255, the motor rotation MotAg and a direction of movement of the driven pulley 543 changes, causing a slight moving back (i.e., “move back” as shown in FIG. 2B) in the movement of the driven pulley 543 such that the parking pawl 255 is able to be completely seated on the driven pulley 543 (e.g., after the “move back”, a terminal end/surface of the parking pawl 255 furthest away from the pivoting mechanism may be seated against a flat surface of at least one tooth of the driven pulley 543).

This slight move back in the movement of the driven pulley 543 is shown in the blow-up portion 238 of the graph 234 where the motor rotation MotAg is shown to dip slightly after reaching a peak point of movement. This dip (e.g., change) in the motor rotation MotAg indicates that the parking pawl 255 is completely seated on at least one tooth of the driven pulley 543 in one of the three example positions shown in FIG. 2B. All three example positions shown in FIG. 2B show the parking brake being engaged in a stable condition (also referred to herein as a “stable parking brake state”) where the parking pawl 255 is in little to no risk of disengaging with (e.g., falling out form) the driven pulley 543 when the vehicle is fully parked.

In embodiments, such motor torque MotTq and motor rotation MotAg may be monitored by the controller 700 via one or more sensors (not shown) (e.g., torque sensors, rotation sensors, movement sensors, inductive position sensors, or the like) that are installed within the brake assembly 10 within a predetermined proximity of the electric motor 520 and that are configured to sense various characteristics and properties of the electric motor 520. In embodiments, the motor rotation MotAg may also be converted (and/or be replaced) using a motor angle (e.g., motor position) of the electric motor 520 by controller 700.

On the other hand, as shown in FIG. 2C, another instance of graph 234 is shown where the parking pawl 255 engages with the driven pulley 543 in an unstable condition (also referred to herein as a “unstable parking brake state”) or even slides off the driven pulley 543 due to high friction being present between the driven pulley 543 and the parking pawl 255. In one example condition shown in FIG. 2C (e.g., the unstable condition), the parking pawl 255 may engaged with a top land 231 of a gear tooth of the driven pulley 543. The top land 231 may be any surface at the top-most tip (e.g., a terminal end) of a gear tooth of the driven pulley 543. If any portion of the parking pawl 255 engages with the top land 231 of a gear tooth of the driven pulley 543, the parking pawl 255 is at risk of being dislodged from (e.g., disengaged with) the driven pulley 543 when one or more unexpected external input is applied to the vehicle while the vehicle is parked, which causes the parking brake to come undone (e.g., become released). This could be dangerous if the vehicle is parked in position that could cause it to move (e.g., on a slope, or the like) if the parking brake comes undone.

As shown in the blown-up portion 244 of the other instance of graph 234 of FIG. 2B, when the parking pawl 255 engages with the driven pulley 543 in the unstable condition, the motor rotations MotAg1 shows little to no change (e.g., as compared to the dip in the motor rotation MotAg shown in FIG. 2A) after reaching a peak value as the motor torque MotTq begins to ramp downward. This is because the parking pawl 255, when engaged with the top land 231 of a tooth of the driven pulley 543, prevents the electric motor 520 from rotating to cause the change in the direction of movement of the driven pulley 543. Thus, until the parking brake is released again at point 246 of the graph 234, the motor rotation MotAg1 will remain the same (e.g., show no change).

Using such changes in the motor torque MotTq and motor rotation MotAg1 as measured by the controller 700, the unstable condition of the parking brake can be advantageously detected to prevent the brake assembly 10 from entering into the unstable condition (e.g., the unstable parking brake state).

Similarly, when the parking pawl 255 slides off the driven pulley 543, there will be little to no change in the motor rotation MotAg2 at point 236. However, and different from motor rotation MotAg1, because the parking pawl 255 is no longer in contact with driven pulley 543 after sliding off the driven pulley 543, the rotation MotAg2 will indicate that the parking pawl 255 is in a completely disengaged state even before the parking pawl 255 is caused by controller 700 to disengage at point 246 of motor rotation MotAg1.

Additionally, as shown in both FIGS. 2B and 2C, a point 237 is included on graph 234 to show an end of a parking pawl 255 movement (namely, when actuation of the parking pawl 255 has ended). This is usually when the motor torque MotTq is ramped back down to approximately 0 Nm. Thus, the time between point 236 to point 237 is usually referred to as a parking pawl engaging time of the parking pawl 255, and a change in the motor rotation MotAg, MotAg1, MotAg2 (e.g., as caused by the move back movement of the driven pulley 543) between point 236 and point 237 may be used by controller 700 to determine whether the parking pawl 255 has properly engaged with the driven pulley 543 in a stable condition.

Turning to FIG. 3, a flowchart illustrating a method for managing a parking brake of a brake assembly according to one or more exemplary embodiments of the present disclosure. The operations of the flowchart of FIG. 3 may be performed, for example, by the controller 700 of the brake assembly 10 and/or by a central controller of the vehicle (e.g., a chassis controller or the like) that is separate and operates independently from controller 700 of the brake assembly 10. Although shown as a series of temporal steps, the operations of the flowchart 3 need not be performed in the exact order shown in FIG. 3 and any of the operations can be performed in any order without departing from the scope and spirit of embodiments disclosed herein.

At Operation 300, a request may be received to apply a parking brake (e.g., to transition the vehicle into a parking brake applied state). The request may be received by a driver (e.g., a human driver, a fully and/or semi-autonomous artificial intelligence (AI) based driver, of the like) of the vehicle.

At Operation 302, a ramping down of the motor torque (e.g., motor torque MotTq of FIGS. 2B and 2C) may be determined (e.g., detected, sensed, or the like).

In embodiments, the ramping down of the motor torque may be monitored (as part of Operation 302) until it is determined that a parking pawl engaging time (e.g., as discussed above in reference to FIGS. 2B and 2C) has ended. Alternatively, the ramping down of the motor torque may be monitored (as part of Operation 302) until the motor torque as reached a preset value (e.g., has ramped down to a preset motor torque value). The preset motor torque value may be any value as determined and stored beforehand in the controller 700 (and/or central controller) by a manufacturer of the brake assembly 10 and/or the vehicle.

At Operation 304, once the parking pawl engaging time has ended or once the motor torque as reached (e.g., has ramped down to) a preset value, a determination is made as to whether a change in the motor rotation (e.g., MotAG, MotAG1, and/or MotAG2 of FIGS. 2B and 2C) has exceeded (e.g., is greater than) a preset motor rotation change value.

In embodiments, the motor rotation may also be converted (or substituted) with a motor angle value of the electric motor 520. Additionally, the preset motor rotation change value may be any value as determined and stored beforehand in the controller 700 (and/or central controller) by a manufacturer of the brake assembly 10 and/or the vehicle. This preset motor rotation change value may represent amount of move back by the driven pulley 543 required (e.g., as determined by the manufacturer) for establishing stable parking brake application conditions between the parking pawl 255 and the driven pulley 543.

In the event that the determination at Operation 304 is a “NO” (i.e., that the change in motor rotation is NOT greater than the present motor rotation change value), the process proceeds to Operation 306 where the electric motor 520 is caused to apply a negative torque (e.g., for the parking brake operation). The negative torque may be applied, for example, when the electric motor 520 is controlled to apply a torque in a direction of releasing the brake (e.g., releasing the brake pad assembly 120 from the brake rotor 125).

In particular, the application of the negative torque ensures that the parking pawl 255 and the driven pulley 543 can be properly engaged in high friction situations between the parking pawl 255 and the driven pulley 543. Additionally, such negative torque is only applied during a parking brake application situation as general application of a negative torque (e.g., during vehicle braking/stopping situations or the like) may cause complications and damages to the brake assembly 10 (e.g., may damage one or more components such as the printed circuit board hosting the controller 700, or the like, may unintentionally increase a pad gap between the brake pad assembly 120 and the brake rotor 125, or the like). Essentially, the negative torque applied by the electric motor 520 causes the brake pad assembly 120 to move in the brake release direction.

The amount of negative torque to be applied by electric motor 520 may be any value as determined and stored beforehand in the controller 700 (and/or central controller) by a manufacturer of the brake assembly 10 and/or the vehicle. For example, the amount of negative torque applied may be an amount that is sufficient for the driven pulley 543 to move backwards one tooth length, or the like.

At Operation 308, after the negative torque has been applied by the electric motor 520 in Operation 306, a determination is made to whether the electric motor 520 has stopped within a preset parking pawl set range. The determination may be made by observing a motor angle of the electric motor 520 (e.g., as determined using the motor rotation of electric motor 520 and/or as directly measured using an inductive position sensor or the like) when the electric motor 520 has fully stopped.

In embodiments, the preset parking paw set range may include a set of motor angles that are known and tested to be angles where the driven pulley 543 is set to a position (e.g., by rotation of the electric motor 520) where the parking pawl 255 is certain (e.g., knows) to be fully engaged with the driven pulley 543 if the parking pawl 255 is actuated (e.g., by the actuating mechanism of the parking brake assembly 250. Said another way, the preset parking paw set range contain a list of angles where the parking pawl 255 is certain to engage with the driven pulley 543 in at least one of the three engagement conditions as shown in FIG. 2B.

The preset parking paw set range may be determined beforehand by the manufacturer of the brake assembly 10 and/or the vehicle (e.g., through repeated testing of a parking brake assembly 250, through historical data, or the like), and stored into the memory of the controller 700 (and/or the central controller). The preset parking paw set range stored in the memory of the controller 700 (and/or the central controller) may also be continuously updated (e.g., by controller 700 or the like) through repeated everyday operation of the vehicle to account for normal wear and tear (and/or other external factors such as temperature, friction force, or the like) of the brake assembly 10 and/or parking brake assembly 250.

In the event that the determination at Operation 308 is a “NO” (i.e., that the electric motor 520 has not stopped within the preset parking pawl set range), the process returns back to Operation 306 where the electric motor 520 may be caused to produce additional negative torque (and/or a combination of some negative torque and/or some positive torque) in order to move the electric motor 520 to have a motor angle (from the currently observed motor angle in Operation 308) that is within a present parking pawl set range.

Once the electric motor 520 has been moved to have a motor angle that is within the present parking pawl set range (i.e., once the determination at Operation 308 is now a “YES” after the adjustment of the motor angle of the electric motor 520) the process proceeds to Operation 310 where the parking brake operation may be retried (e.g., reapplied). Because the motor angle is now within the present parking pawl set range, the controller 700 (and/or the central controller) would be sure that the parking pawl 255 would be properly engaged with the driven pulley 543 during this reapplication of the parking brake in Operation 310.

At Operation 310, once the parking brake has been reapplied, the controller 700 (and/or the central controller) may set the parking brake status of the vehicle from “applying” to “applied” to show that the parking brake has been successfully applied (e.g., in a stable parking operation condition).

The method of FIG. 3 may end following Operation 312.

Alternatively, the determination at Operation 304 is a “YES” (i.e., that the change in motor rotation IS greater than the present motor rotation change value), the process proceeds to Operation 308 where the above discussed details of Operations 308 through 312 are performed until the parking brake status of the vehicle is changed from “applying” to “applied”, as is performed in Operation 312.

Any of the operations (e.g., Operations 300 through 308) discussed in reference to FIG. 3 may be performed, in part or whole, by digital processors (e.g., central processors, processor cores, etc.) that execute corresponding instructions (e.g., computer code/software) of controller 700. Execution of the instructions may cause the digital processors to initiate performance of the processes. Any portions of the operations (e.g., Operations 300 through 304) may be performed by the digital processors and/or other devices. For example, executing the instructions may cause the digital processors to perform actions that directly contribute to performance of the operations, and/or indirectly contribute to performance of the operations by causing (e.g., initiating) other hardware components to perform actions that directly contribute to the performance of the operations.

Additionally, any of the operations discussed in reference to FIG. 3 may be performed, in part or whole, by special purpose hardware components of the controller 700 such as digital signal processors, application specific integrated circuits, programmable gate arrays, graphics processing units, data processing units, and/or other types of hardware components. These special purpose hardware components may include circuitry and/or semiconductor devices adapted to perform the operations. For example, any of the special purpose hardware components may be implemented using complementary metal-oxide semiconductor-based devices (e.g., computer chips).

Any vehicle according to certain exemplary embodiments of the present disclosure may be identical, or substantially similar to, vehicle 800 shown in FIG. 4. The vehicle 800 may be any passenger or commercial automobile such as a hybrid vehicle, an electric vehicle, or any other type vehicles. FIG. 4 is a schematic view of a vehicle 800 including a steering system and a brake assembly 860 (e.g., the brake assembly 10 discussed above in reference to FIG. 1) according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820.

In the steer-by-wire steering system, the steering wheel 820 may be mechanically isolated from the road wheels 830. For example, the steer-by-wire system has no mechanical link connecting the steering wheel 820 from the road wheels 830. Accordingly, the steer-by wire steering system may comprise a feedback actuator or steering feel actuator 828 comprising an electric motor which is connected to the steering shaft or steering shaft 822. The feedback actuator or steering feel actuator 828 provides the driver or operator with the same “road feel” that the driver receives with a direct mechanical link.

Although the embodiment illustrated in FIG. 4 shows the vehicle 800 having the steer-by-wire steering system, the vehicle 800 may alternatively have a mechanical steering system without departing from embodiments disclosed herein. The mechanical steering system typically includes a mechanical linkage or a mechanical connection between the steering wheel 820 and the road wheels 830. In the mechanical steering system, the steering actuator motor 834 includes an electric motor to provide power to assist the movement of the road wheels 830 in response to the operation of the driver or a control signal of the controller 850. Accordingly, the electric motor can be used as the steering actuator motor 834 or can be included in the feedback actuator or steering feel actuator 828.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An electromechanical brake (EMB) assembly comprising:
an actuator assembly comprising an electric motor configured to generate torque for moving a brake pad assembly to apply or release a brake and a driven pulley configured to transmit the torque generated from the electric motor;
a parking brake assembly comprising a parking pawl configured to engage against the driven pulley in a parking brake applied state of a vehicle and a pawl actuator configured to move the parking pawl to engage against the driven pulley; and
an electronic control unit (ECU) coupled to the actuator assembly and the parking brake assembly, the ECU configured to control the electric motor by determining whether the electric motor should be controlled to apply the torque in a direction of releasing the brake to ensure a stable engagement between the parking pawl and the driven pulley during the parking brake applied state of the vehicle based on change in motor rotation of the electric motor.

2. The EMB assembly of claim 1, wherein the ECU is configured to, as part of determining whether the electric motor should be controlled to apply the torque in a direction of releasing the brake:
obtain a request to apply the parking brake assembly to transition the vehicle into the parking brake applied state;
cause, in response to the request to apply the parking brake, the parking pawl to engage with the driven pulley;
determine, after the parking pawl is caused to engage with the driven pulley, whether the change in the motor rotation of the electric motor has exceeded a preset motor rotation change value; and
control the electric motor to apply the torque in the direction of releasing the brake based on the determination of whether the change in the motor rotation of the electric motor has exceeded the preset motor rotation change value.

3. The EMB assembly of claim 1, wherein the ECU is configured to, in response to a determination that the change in the motor rotation of the electric motor has exceeded a preset motor rotation change value, control the electric motor not to apply the torque in the direction of releasing the brake.

4. The EMB assembly of claim 1, wherein the ECU is configured to, in response to a determination that the change in the motor rotation of the electric motor has not exceeded a preset motor rotation change value, control the electric motor to apply the torque in the direction of releasing the brake.

5. The EMB assembly of claim 2, wherein the ECU is further configured to determine a starting point and an ending point of a parking pawl engaging time of the parking pawl based on the torque of the electric motor, wherein the change in the motor rotation of the electric motor is a change in the motor rotation measured between the starting point and the ending point of the parking pawl engaging time.

6. The EMB assembly of claim 2, wherein the ECU is further configured to determine, after the parking pawl is caused to engage with the driven pulley and using a motor torque of the electric motor, whether the torque of the electric motor has ramped down from a peak motor torque value to a preset motor torque value, wherein the change in the motor rotation of the electric motor is a change in the motor rotation measured between the peak motor torque value and the preset motor torque value.

7. The EMB assembly of claim 1, wherein the ECU is configured to control the electric motor to apply the torque in the direction of releasing the brake to move the driven pulley to a parking pawl set range preset for a stable parking brake applied condition based on the change in the motor rotation of the electric motor.

8. An electromechanical brake (EMB) assembly comprising:
a brake rotor configured to be rotatable with a wheel of a vehicle;
a brake pad assembly configured to be engageable with the brake rotor;
an actuator assembly comprising an electric motor configured to generate torque for moving the brake pad assembly and a driven pulley configured to transmit the torque generated from the electric motor;
a parking brake assembly comprising a parking pawl configured to engage against the driven pulley in a parking brake applied state of the vehicle and a pawl actuator configured to move the parking pawl to engage against the driven pulley; and
an electronic control unit (ECU) coupled to the actuator assembly and the parking brake assembly, the ECU configured to control the electric motor by determining whether the electric motor should be controlled to apply the torque in a direction of releasing the brake to ensure a stable engagement between the parking pawl and the driven pulley during the parking brake applied state of the vehicle based on change in motor rotation of the electric motor.

9. The EMB assembly of claim 8, wherein the ECU is configured to, as part of determining whether the electric motor should be controlled to apply the torque in a direction of releasing the brake:
obtain a request to apply the parking brake assembly to transition the vehicle into the parking brake applied state;
cause, in response to the request to apply the parking brake, the parking pawl to engage with the driven pulley;
determine, after the parking pawl is caused to engage with the driven pulley, whether the change in the motor rotation of the electric motor has exceeded a preset motor rotation change value; and
control the electric motor to apply the torque in the direction of releasing the brake based on the determination of whether the change in the motor rotation of the electric motor has exceeded the preset motor rotation change value.

10. The EMB assembly of claim 8, wherein the ECU is configured to, in response to a determination that the change in the motor rotation of the electric motor has exceeded a preset motor rotation change value, control the electric motor not to apply the torque in the direction of releasing the brake.

11. The EMB assembly of claim 8, wherein the ECU is configured to, in response to a determination that the change in the motor rotation of the electric motor has not exceeded a preset motor rotation change value, control the electric motor to apply the torque in the direction of releasing the brake.

12. The EMB assembly of claim 9, wherein the ECU is configured to determine a starting point and an ending point of a parking pawl engaging time of the parking pawl based on the torque of the electric motor, wherein the change in the motor rotation of the electric motor is a change in the motor rotation measured between the starting point and the ending point of the parking pawl engaging time.

13. The EMB assembly of claim 9, wherein the ECU is configured to determine, after the parking pawl is caused to engage with the driven pulley and using a motor torque of the electric motor, whether the torque of the electric motor has ramped down from a peak motor torque value to a preset motor torque value, wherein the change in the motor rotation of the electric motor is a change in the motor rotation measured between the peak motor torque value and the preset motor torque value.

14. The EMB assembly of claim 8, wherein the ECU is configured to control the electric motor to apply the torque in the direction of releasing the brake to move the driven pulley to a parking pawl set range preset for a stable parking brake applied condition based on the change in the motor rotation of the electric motor.

15. A method for controlling an electromechanical brake (EMB) assembly, the method comprising:
determining whether an electric motor of the EMB assembly should be controlled to apply a torque in a direction of releasing a brake to ensure a stable engagement between a driven pully, configured to transmit the torque generated from the electric motor, and a parking pawl, configured to engage against the driven pulley in a parking brake applied state of a vehicle, during the parking brake applied state based on change in motor rotation of the electric motor; and
controlling the electric motor of the EMB assembly in response to determination of whether the electric motor of the EMB assembly should be controlled to apply the torque in the direction of releasing the brake during the parking brake applied state based on the change in the motor rotation of the electric motor.

16. The method of claim 15, wherein the determining whether the electric motor should be controlled to apply the torque in the direction of releasing the brake comprises:
obtain a request to apply the parking brake assembly to transition the vehicle into the parking brake applied state;
causing, in response to the request to apply the parking brake, the parking pawl to engage with the driven pulley;
determining, after the parking pawl is caused to engage with the driven pulley, whether the change in the motor rotation of the electric motor has exceeded a preset motor rotation change value; and
controlling the electric motor to apply the torque in the direction of releasing the brake based on determination of whether the change in the motor rotation of the electric motor has exceeded the preset motor rotation change value.

17. The method of claim 16, wherein the controlling the electric motor comprises, in response to a determination that the change in the motor rotation of the electric motor has exceeded the preset motor rotation change value, controlling the electric motor not to apply the torque in the direction of releasing the brake.

18. The method of claim 16, wherein the controlling the electric motor comprises, in response to a determination that the change in the motor rotation of the electric motor has not exceeded the preset motor rotation change value, controlling the electric motor to apply the torque in the direction of releasing the brake.

19. The method of claim 16, wherein the determining, after the parking pawl is caused to engage with the driven pulley, whether the change in the motor rotation of the electric motor has exceeded the preset motor rotation change value comprises:
determining a starting point and an ending point of a parking pawl engaging time of the parking pawl based on the torque of the electric motor, wherein the change in the motor rotation of the electric motor is a change in the motor rotation measured between the starting point and the ending point of the parking pawl engaging time.

20. The method of claim 15, wherein the electric motor is controlled to apply the torque in the direction of releasing the brake based on the change in the motor rotation of the electric motor to move the driven pulley to a parking pawl set range preset for a stable parking brake applied condition.
